(19) United States
(12) Patent Application Publication
(10) Pub. No.: US 2008/0151245 A1
(43) Pub. Date: Jun. 26, 2008

(54) METHOD AND A DEVICE FOR PROCESSING BIREFRINGENT AND/OR OPTICALLY ACTIVE MATERIALS AND PHASE PLATE

(75) Inventor: Damian Fiolka, Oberkocken (DE)

Correspondence Address: SUGHRUE MION, PLLC, 2100 PENNSYLVANIA AVENUE, N.W., SUITE 800, WASHINGTON, DC, 20037, US

(73) Assignee: Carl Zeiss SMT AG, Oberkochen (DE)

(21) Appl. No.: 11/950,153

(22) Filed: Dec. 4, 2007

(30) Foreign Application Priority Data
Dec. 4, 2006 (DE) 102006057104.5

(51) Int. Cl. G01J 4/00; G02B 5/30

(52) U.S. Cl. 356/365; 359/494; 359/496

(57) ABSTRACT

A method and a device for processing birefringent and/or optically active materials, wherein a light source (3) for polarized light and an analyzer assembly (8) and a light sensor (9) connected therewith are provided, so that between said components a processing of the birefringent and/or optically active material can be performed, so that the length of the pass-through path of the light through the material to be processed is changed, wherein the light is detected and processed simultaneously in a continuous or intermittent manner at the light sensor placed after the analyzer assembly, so that conclusions are derived from the changes of the light properties at the light sensor with respect to the processing state. Also provided is a combination phase plate manufactured accordingly.

### BACKGROUND OF THE INVENTION

1. Field of the Invention

The present invention relates to a method and to a device for processing birefringent and/or optically active materials and to a respective product, which can be produced therewith.

2. Prior Art

In the state of the art, the use of birefringent and/or optically active materials is generally known. Birefringent materials are being used e.g. in the form of so-called phase shifters, delay plates or wave plates, in which the optical axis of the birefringent material is present in the plate plane. When light in the form of a planar wave impacts vertically onto a respective phase or delay plate, a phase shift of light components relative to each other occurs with reference to the light components with a polarization direction in parallel to the optical axis and perpendicular to the optical axis, due to the different propagation velocities. When the phase shift is λ/2, this is called a λ/2 plate or half-wave plate while during a phase shift by λ/4 or integer multiples thereof, these are called λ/4 platelets or quarter-wave plates.

In DE 10 2006 046674.8, an application of quarter-wave plates and half-wave plates is described in a microlithographic projection objective, in which segments of λ/4 phase plates and λ/2 phase plates are mechanically joined into a phase plate.

Such combination phase plate is difficult to manufacture, since the partial segments from λ/2 and λ/4 phase plates have to be precisely assembled relative to each other, wherein only small tolerances are available. Furthermore, undesired gaps between segments can occur through temperature effects or tensions can occur when the plates are assembled too close to each other. Furthermore, difficulties can occur, when antireflection coatings are disposed.

### SUMMARY OF THE INVENTION

### Object of the Invention

Therefore, it is an object of the invention to provide a method and a device, through which combination phase plates can be manufactured in a simple manner. Furthermore, an improved combination phase plate shall also be provided.

### Technical Solution

The present object may be accomplished through a method, a device, and/or a delay plate e.g. as recited particularly in the claims.

Advantageous embodiments are the objects of the dependent claims.

The invention is based on the finding, that a respective combination phase plate, as it is assembled according to the state of the art from two separate segments, can be manufactured e.g. through the use of a masking or shadowing with reference to a part of a phase plate from a single piece. Accordingly, a delay plate is suggested, according to a first aspect of the invention, which is formed as a monolithic plate from a birefringent material, and which has two sectors, which differ in their phase shift, wherein in particular a first section with a phase shift of λ/2 or an integer multiple thereof and a second section with a phase shift of λ/4 or respective integer multiples thereof are present.

The manufacture of a monolithic phase plate with two sectors of different phase shift can be performed in a simple manner through a partial or sectional change of the thickness of the phase plate, and thus of the travel distance for light passing through, a respective change of the phase shift for light passing through is adjusted. A partial thickness change can be accomplished according to another aspect of the invention through a masking or shadowing technique, wherein the components of the phase plate, in which no materials removal shall occur, are masked or shadowed, while in the remaining sections, in which material removal shall be performed, no masking or shadowing with respect of the materials removal occurs.

According to the state of the art method, the adjustment of the thickness of a phase plate with respect to the desired phase shift is performed through a respective theoretical determination of the necessary thickness and approach to this thickness through a respective processing of the birefringent material. Hereby, then respective typical values are used, e.g. with respect that the required processing time is determined from a known material removal rate per unit time. In case the desired thickness of the phase plate has not been reached yet, respective rework becomes necessary. This method, however, is very laborious, so that according to another aspect of the present invention an improved, more effective method is introduced, which can be used generally for processing birefringent and/or optically active materials, in which a change of the polarization state of the light passing through the material can be achieved through material removal.

The method according to the invention and the accordingly created device are based on the finding that the change of the polarization state of light, which passes through the birefringent and/or optically active material to be processed, can be used for a more precise determination of the processing state, this means of the material removal. Through the processing of the birefringent and/or optically active material, this means through the material removal, thus a change of the travel distance occurs, which the light passes in the material to be processed. Thereby, also the polarization state of the light, which leaves the material to be processed again, is changed with increasing material removal, when the material to be processed and the polarization of the light are adjusted, so that upon passing through the material to be processed a change of the polarization state, this means a phase shift or rotation of the polarization plane, occurs.

Accordingly, the method, according to the invention, and the device, according to the invention, provide for a light source for polarized light, an analyzer assembly, and a light sensor associated with the analyzer assembly, and a processing unit connected in between, in which the birefringent and/or optically active material is processed, so that the travel distance of the light changes in the material to be processed through the processing. Accordingly, light can be detected at the light sensor continuously or in an intermittent manner, and from the changes of the light properties, like e.g. light intensity, the achieved thickness of the material to be processed or the material that has already been removed can be recalculated.

Thus, it can be determined directly in a simple manner, if the desired processing goal has already been accomplished or not. As soon as it is determined, that the processing goal is reached, the processing can be interrupted immediately.

As a light source a light source can be used, which directly generates polarized light, like e.g. a laser, or a light source with natural light, which comprises randomly polarized light, wherein in this case, a respective polarizer is disposed subsequent to the light source in order to generate polarized light.

All kinds of polarizers can be used as polarizer, in particular polarization prisms made of birefringent crystals, polarization filters of dichroitic materials, interference polarizers from systems with thin layers, reflection polarizers with reflecting or permeable boundary surfaces, phase plates or wire grid polarizers.

Since birefringence is also wavelength dependent, preferably monochromatic light can be used, which can be adapted to the desired application of the birefringent and/or optically active material.

According to an embodiment, the polarizer for generating different polarization states can be pivoted or rotated around the axis of the light beam, so that e.g., in case of a linear polarizer, the polarization plane falls periodically in different orientation onto the birefringent and/or optically active material to be processed. Thereby, it can be assured that different angles between polarization plane and optical axis of the birefringent material are adjusted, so that, independent from the orientation of the material to be processed, states are reached, in which the polarized light experiences a change of the polarization state when passing through the material to be processed.

The analyzer assembly, which is disposed subsequent to the material to be processed in the beam path, can be formed by suitably aligned polarizers or can include them, as they have already been mentioned in the above for the polarization of the light.

In particular, the analyzer assembly can comprise a polarimeter setup, in which a delay or phase plate rotating around the axis of the light beam, in particular a λ/4 phase plate, and a subsequent analyzer element of a respective polarizer are provided.

In such a setup, a periodic intensity change of the light is caused at the light sensor, which is disposed after the analyzer assembly, depending how the polarized light can pass through the rotating λ/4 plate and the subsequent analyzer element.

Through the material removal, occurring at the same time, at the birefringent and/or optically active material, additionally a change of the polarization state of the light is caused through the change of the travel length of the light through the material to be processed, which can be detected through a superimposed intensity change in addition to the periodic intensity change through the polarimeter assembly at the light sensor.

Alternatively, also an analyzer element can be disposed in the form of a corresponding polarizer rotating around the axis of the light beam, in order to also cause a periodic change of the light intensity at the light sensor.

Through the periodic change of the light intensity at the light sensor, a change of the polarization state of the light caused by the material removal and a corresponding superimposed intensity change of the light at the light sensor can be detected in a more simple and exact manner.

In the simplest case, only an analyzer element, e.g. a polarizer, which e.g. comprises a polarization plane perpendicular to the linear polarized light of the light source, can be provided, so that a change of the polarization state of the light, caused by passing through the material to be processed, depending on its processing state, this means material removal, can be detected through a respective change of the pass-through intensity at the light sensor. A prerequisite for this is only, that the material to be processed is disposed with reference to the polarized light, so that a change of the polarization state occurs upon passage. In case linear polarized light is provided with its polarization plane at an angle, relative to the optical axis of a λ/2 plate to be processed, the phase shift between the ordinary and extraordinary beam will lead with increasing processing, this means material removal of the λ/2 plate to a change of the light quantity passed through by the analyzer element, which can be directly detected by the light sensor as a changed light intensity.

Thus, in particular a determination of the thickness of the material to be processed or the material removal is possible in real time or almost in real time during the processing.

As a light sensor, an energy sensor, in particular in the form of a CCD (charge coupled device) photo sensor can be used.

The device and the method thus function so that the material to be processed is irradiated with polarized light during materials processing, this means during material removal, continuously or intermittingly, this means temporarily e.g. between processing steps, wherein due to the change of the travel distance of the light through the material to be analyzed, a change of the polarization state occurs, which can be detected through the analyzer assembly and the photo sensor. Accordingly, the data of the photo sensor can then be collected in an evaluation unit, e.g. in a data processing unit, and processed therein so that the thickness of the material to be processed or the material removal is recalculated. As soon as the desired material removal or the thickness of the material to be processed are reached, a termination of the processing can be caused by the processing unit, so that directly after reaching the desired processing state, the optimally produced work piece is present without requiring further rework.

Through this method and the respective device, a λ/4 phase plate can thus be produced in a simple manner, starting with a λ/2 phase plate through material removal, in particular in a certain partial area, so that the above mentioned combination phase plate can be produced very precisely in a simple manner. The accuracy of processing can be determined by the accuracy of the properties being achievable with the inventive delay plate or combination plate. Accordingly, the inventive method allows achieving a phase shift with an accuracy better than 2 nm, preferably 1 nm. Accordingly, the orientation of polarization of a light passing the delay plate is better than 2°, preferably 1°. Similarly, the accuracy of the phase of polarization achieved in light passing the delay plate is better than 2 nm, preferably 1 nm. Correspondingly, the thickness of the delay plate or at least one section thereof can be set such that the deviation is smaller than 200 nm, preferably 100 nm. Furthermore, the method and the device also provide the possibility to process other birefringent and/or optically active components, e.g. diffractive optical components, in which a surface structure is generated.

The processing can be performed in a different manner, e.g. through ion etching or through a wet chemical processing. Here, however, also other methods for an even and precise material removal are conceivable, which can be used together with the method according to the invention or the respective device.

When a processing method is selected, in which the material to be processed is exposed to certain temperature influences, a compensation element can be provided, which is preferably made from the same material or similar material as the material to be processed, and which approximately experiences the same temperature as the material to be processed. This can be e.g. accomplished through the compensation element being disposed close to the material to be processed, wherein it is nevertheless advantageous to provide a certain distance.

The compensation element can be selected so that the travel length of the light in the compensation element corresponds to the travel length of the light in the material to be processed after the processing, this means it has the desired target thickness.

When using linear polarized light for processing birefringent material, in which the optical axis is provided e.g. in the plate plane of a plate shaped material to be processed, the optical axis of material to be processed and compensation element are disposed perpendicular to each other. In case of optically active material, the optical axes of the material to be processed and the compensation element are disposed in parallel, wherein disposition is performed so that the rotating direction of the material to be processed and the compensation element are opposite, this means e.g. left or right rotating silica. Thus, the material to be processed and the compensation element differ only in the rotating direction and they are thus similar in the sense of the present application.

### BRIEF DESCRIPTION OF THE FIGURE

Further advantages, characteristics and features of the present invention become apparent with reference to the following description of preferred embodiments, based on the appended drawing. The only illustration herein shows in a purely schematic manner the process for manufacturing a combination phase plate according to the invention.

### PREFERRED EMBODIMENTS

In the illustration, the various steps (step 1 through step 6) for producing a combination phase plate according to the invention with a sector of a λ/2 phase shift and a second sector of a λ/4 phase shift are schematically shown, wherein the phase plate and to some extent the corresponding processing device are illustrated in a side view in the upper partial images, wherein in the lower partial images, the respective top views, however, only for the phase plate, are shown.

In a first step (step 1), a birefringent λ/2 phase plate of higher order is provided, which has sufficient mechanical stability. The order of the phase plate designates, to how many integer multiples of 2π plus the desired phase difference φ or λ/2, λ/4, etc., the thickness of the phase platelet corresponds. Furthermore, λ/2 phase plates of the order 5 to 15 can typically be selected for the intended application of the combination phase plate in objectives, e.g. for microlithography. In phase plates of higher order, thus also the thickness range for the λ/4 range to be generated is covered.

Since the combination phase plate to be manufactured is supposed to be a monolithic phase plate, comprising at least two areas or segments causing a different phase shift, in the next step (step 2), a masking 2 is applied on the λ/2 phase plate 1, covering the angular range or the segment, which after processing the λ/2 phase plate is furthermore to effect a phase shift by λ/2. Through the masking it is assured, that during the subsequent processing (step 3) the masked or covered range of the λ/2 phase plate is not affected.

In the next step, now the processing of the birefringent material in form of the λ/2 phase plate is performed. For this purpose, a device according to the invention is used, comprising a processing chamber 6, in which an ion source 5 is disposed.

The λ/2 phase plate 1 to be processed is disposed in the processing chamber 6 opposite to the ion source 5, so that the ions 7 accelerated from the ion source 5 to the phase plate 1 lead to a material removal on the surface of the phase plate 1, facing the ion source 5. This, however, only applies for the angle range or the segment in which no masking 2 in the form of a material resistive against ion bombardment is disposed.

Instead of a masking, which is disposed directly on the material to be processed, i.e. the phase plate 1, also an aperture can be used, which is offset from the material to be processed, which leads e.g. in cooperation with the ion etching device to a shadowing with respect to the ions originating from the ion source 7, and thus avoids a processing of the surface of the phase plate 1 in this area. Such an aperture can be provided adequately in the processing chamber and can be used for a plurality of work pieces to be processed.

Instead of an ion etching device, also other devices can be provided, through which a material removal from the surface of the material to be processed can be performed, which is as even as possible. For example, a processing through wet chemical etching would be conceivable, in which the processing chamber 6 can be filled with chemical etching means, wherein then the material to be processed would e.g. be submerged into the etching compound with a respective masking.

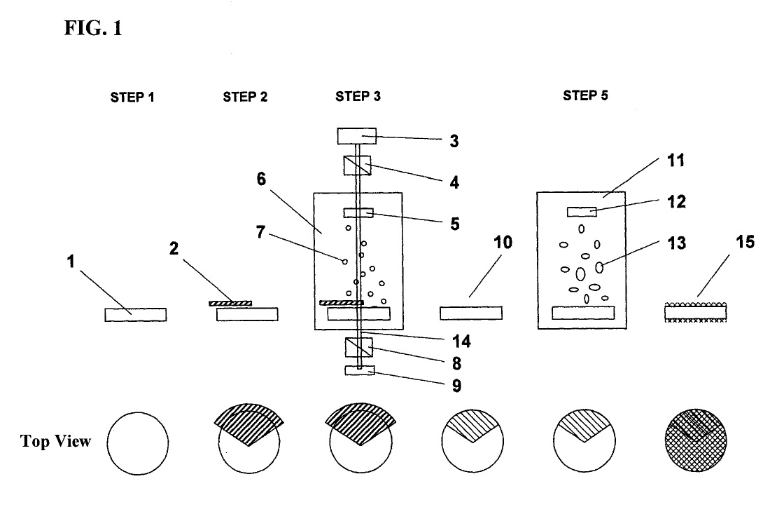

In order to be able to determine exactly, when the required material removal in the angle range or segment, which is to be converted into a sector with λ/4 phase shift, the device according to the invention provides a light source 3 and a polarizer 4, by which polarized light can be radiated through the range of the phase plate 1 to be processed, in order to be able to determine the processing state of the phase plate 1 after the passage through the phase plate 1 by an analyzer assembly 8 and an energy sensor 9. In the schematic illustration of FIG. 1 in step 3, a respective light beam is schematically designated with the reference numeral 14. The radiation passage can be performed permanently or in intervals, e.g. when the ion source 5 is pivoted out of the beam path.

Instead of a light source 3, which generates natural light with a plurality of random polarization states and a subsequently disposed polarizer, which adjusts a certain polarization state, e.g. a linear polarization, also a light source can be used, which generates polarized light right from the beginning, e.g. a laser. A laser furthermore has the advantage that it generates monochromatic light, which can e.g. be adapted to the application, this means the λ/2 phase plate to be processed. When the polarized light impacts the λ/2 phase plate with an angle between the polarization direction of the light and the optical axis of the λ/2 phase plate being unequal to 0° or 180° (and integer multiples thereof), the polarized light goes through a phase shift between the ordinary and extraordinary beams, which is caused by the birefringence, which can then be made visible through the analyzer assembly 8 for the light sensor 9. Through the material removal at the surface of the phase plate 1, a change of the phase shift between ordinary and extraordinary beam occurs, as a consequence of the thickness change of the phase plate 1, which can be detected over time through the analyzer assembly 8 in connection with the light sensor 9.

The analyzer assembly can be given through a polarimeter assembly, which e.g. comprises a rotating λ/4 phase plate and a beam splitter, which only passes light with a certain polarization, for example linear polarized light, whose polarization plane is perpendicular to the polarization plane of the light source, while the light is deflected with other polarization states. Thus, the light intensity can be detected over time by the energy sensor 9, and the processing state, this means the thickness of the phase plate 1 can be recalculated. Thus, the processing, this means the material removal, can be stopped exactly when the desired property of the λ/4 phase shift is accomplished.

As an alternative to the polarimeter assembly of the analyzer assembly 8, e.g. also an analyzer element in the form of a polarizer can be used, which can be disposed rotating around the axis of the light beam in the light beam 14, in order to generate a periodic change of the light intensity at the subsequent light sensor through a variation of the angle between the polarization direction of the analyzer element and the polarization of the light. Through the thickness change of the λ/2 phase plate due to the material removal, there is a superimposed change of the polarization state of the light, so that the material removal can be recalculated from the change of the periodic intensity of the light detected at the light sensor.

In the simplest case, however, a fixed analyzer can be used, whose polarization plane is perpendicular to the polarization of the light used. In case of linear polarized light, which impacts on the optical phase plate 1 with its polarization plane having an angle relative to the optical axis of the phase plate 1, there is a change of the polarization of the light beam 14 through the phase shift between the ordinary and extraordinary beam. Through the analyzer assembly 8, with an analyzer element in the form of e.g. a polarization dependent beam splitter, respective parts of the light beam 14 are deflected from the beam, so that at the light sensor with increasing material removal, a different light intensity is measured, which is used for determining the end of the materials removal.

As an alternative to a rotating analyzer element, also the polarizer, which is disposed in front of the light source 3, can be disposed rotatable, in order to generate through its rotation a time variable angular relationship between the polarization plane of the light and the one of the analyzer assembly 8 and the optical axis of the material to be processed.

The data captured by the light sensor 9, which can e.g. be provided as a CCD sensor, can automatically be processed by an evaluation unit comprising for example a respectively equipped data processing system, so that from the change of the light intensity over time, a conclusion is made with respect to the material removal at the phase plate 1.

As soon as enough material has been removed at the phase plate 1, so that in the respective angle range or segment a λ/4 phase shift is given, the ion source 5 is turned off and the material removal is stopped.

The respective combination phase plate 10 can thus be removed from the processing chamber 6 and can be treated further in subsequent processing steps.

In the illustrated embodiment, in an additional step (step 5), an antireflection coating is deposited in a coating unit 11 through a coating source 12, wherein the coating material is designated as 13.

After a complete coating with antireflection layers, the completely coated combination phase plate 15 can be removed from the coating unit.

Through the shown method, a combination phase plate comprising a first segment, in which a λ/2 phase shift is present, and a second segment, in which a λ/4 phase shift is present, is provided as a one-piece or monolithic component, so that respective mechanical couplings of two segments and the problems resulting therefrom can be avoided.

The illustrated method can generally be used for birefringent or optically active materials, in which the materials removal can be recalculated through measuring polarization properties.

In particular, the method according to the invention can be used for producing structured, diffractive optical elements (DOE) or for exact processing of phase plates or other birefringent or optically active elements.

Though the method according to the invention and the device according to the invention and the respective combination phase plate have been described in detail with respect to the described embodiments, it is appreciated by a person skilled in the art that variations and changes, in particular in the form of a different combination of particular features or omitting particular features can be performed without departing from the scope of the appended claims.

What is claimed is:

1. A method for processing at least one of a birefringent and optically active material, comprising:
a) providing a light source for polarized light;
b) providing an analyzer assembly and a light sensor connected therewith;
c) disposing the at least one of birefringent and optically active material between the light source and the analyzer assembly;
d) processing the at least one of birefringent and optically active material so that the length of the pass-through path of the light through the material to be processed is changed, wherein simultaneously continuously or intermittently the light is detected at the light sensor;
e) evaluating the light detected at the light sensor with respect to the effected changes of the property of the light, and determining, directly or at intervals, the change of the pass-through path from the property change of the light.

2. A method according to claim 1, wherein the steps are carried out in the sequence of enumeration.

3. A method according to claim 1, wherein a light source is used, which generates at least one out of directly polarized light and randomly polarized light.

4. A method according to claim 3, wherein in combination with the light source a polarizer is used.

5. A method according to claim 4, wherein at least one polarizer is used out of the group comprising polarization prisms made from birefringent crystals, polarization filters from dichroitic materials, interference polarizers made from thin layer systems, reflection polarizers with reflecting or permeable boundary surfaces, phase plates and wire grid polarizers.

6. A method according to claim 1, wherein monochromatic light is being used.

7. A method according to claim 1, wherein the polarizer for generating different polarization conditions is pivoted or rotated around the axis of the light beam.

8. A method according to claim 1, wherein for at least part of an analyzer assembly at least one out of the group comprising polarization prisms of birefringent crystals, polarization filters of dichroitic materials, interference polarizers of thin layer systems, reflection polarizers with reflecting or permeable boundary surfaces, phase plates and wire grid polarizers is used.

9. A method according to claim 1, wherein as an analyzer assembly a polarimeter with a λ/4 wave plate rotating around the axis of the light beam and an analyzer element made from a polarizer are used.

10. A method according to claim 1, wherein at least part of the analyzer assembly is pivoted or rotated around the axis of the light beam for detecting different polarization states.

11. A method according to claim 1, wherein as a light sensor at least one of an energy sensor and a CCD (charge coupled device) photo sensor is used.

12. A method according to claim 1, wherein evaluation of the birefringent material comprises at least one of the processes of the group comprising etching, chemical etching, wet chemical etching and ion etching.

13. A method according to claim 1, wherein the evaluation of the light detected by the light sensor and the determination of the change of the pass-through distance through the birefringent material is automatically performed in a data processing system.

14. A method according to claim 13, wherein evaluation and determination are performed in real time.

15. A method according to claim 1, wherein evaluation of the light detected by the light sensor comprises or consists of at least one out of determining the light intensity and matching with a predetermined light intensity.

16. A method according to claim 1, wherein the material to be processed is used as a plate shaped material, in which the optical axis is disposed in the plane of the plate.

17. A method according to claim 1, wherein the material to be processed is used as a plate shaped material, in which the optical axis is disposed perpendicular to it.

18. A method according to claim 1, wherein the optical axis of the material to be processed is disposed at an angle relative to the polarization direction of the polarized light.

19. A method according to claim 1, wherein the material to be processed is a diffractive optical element (DOE), in which a surface structure is generated.

20. A method according to claim 1, wherein the material to be processed is a wave plate.

21. A method according to claim 1, wherein the material to be processed is a λ/2 phase plate.

22. A method according to claim 1, wherein the material to be processed is a wave plate, whose thickness is partially changed, so that a phase shift results, which is different from the remaining sections of the wave plate.

23. A method according to claim 22, wherein a λ/2 phase plate is transformed to a λ/4 phase plate in at least one segment through material removal.

24. A method according to claim 22, wherein a λ/2 phase plate is transformed to a λ/4 phase plate in at least one segment of more that 180° through material removal.

25. A method according to claim 1, wherein only part of the material to be processed is processed, wherein the remaining part is excluded from processing through arranging at least one of apertures and maskings.

26. A method according to claim 1, wherein for compensating temperature influences, a compensation element made of one out of same and similar materials as the material to be processed is provided, which incurs approximately the same temperature as the material to be processed.

27. A method according to claim 26, wherein the compensating element is located near by the material to be processed.

28. A method according to claim 26, wherein the compensating element is located offset at a distance to the material to be processed.

29. A method according to claim 26, wherein the compensation element is selected such so that the travel length of the light in the compensation element corresponds to the travel length of the light in the material to be processed after the processing.

30. A method according to claim 26, wherein the optical axes of the material to be processed and of the compensation element are disposed perpendicular to each other.

31. A method according to claim 26, wherein the optical axes of the material to be processed and the compensation element are disposed in parallel, wherein the optical activity of the material to be processed and the compensation element are selected so that their rotating capability is opposed.

32. A device for processing at least one of birefringent and optically active materials comprising
a) a light source for polarized light,
b) an analyzer assembly and a light sensor connected therewith; and
c) a processing unit, provided between the light source and the analyzer assembly for processing at least one of the birefringent and optically active material, so that the length of the pass-through path of the light through the material is changed.

33. A device according to claim 32, wherein an evaluation unit is provided, detecting the data of the light sensor and determining the processing state of the material to be processed from the light data.

34. A device according to claim 33, wherein the evaluation unit comprises a data processing system.

35. A device according to claim 33, wherein the evaluation unit is designed such that determining the processing state is carried out continuously or stepwise.

36. A device according to claim 33, wherein the device is provided so that simultaneously with the processing of the material to be processed, the light can be detected at the light sensor.

37. A device according to claim 32, wherein the processing unit comprises a processing chamber, in which the processing means are provided.

38. A device according to claim 37, wherein the processing means are selected from the group comprising chemical etching compounds and an ion etching device.

39. A device according to claim 37, wherein the processing means are disposed such that they are removable from the beam path of the light

40. A device according to claim 37, wherein the processing means are disposed such that they are pivotable.

41. A device according to claim 32, wherein moving devices are provided for at least one of a polarizer and an analyzer element, wherein their operating state can be detected through detection means and can be transmitted to the evaluation unit.

42. A delay plate made from a birefringent material, wherein the delay plate is a monolithic plate comprising at least sections which differ in their phase shift.

43. A delay plate according to claim 42, wherein a first section with a phase shift of λ/2 and a second section with a phase shift of λ/4 is provided.

44. A delay plate according to claim 42, wherein the delay plate causes light passing the delay plate to have a polarization distribution having at least two polarization conditions being offset locally.

45. A delay plate according to claim 42, wherein an accuracy of the phase shift set in at least one section is better than 2 nm.

46. A delay plate according to claim 42, wherein an accuracy of the phase shift set in at least one section is better than 1 nm.

47. A delay plate according to claim 42, wherein an accuracy of the orientation of polarization achieved in light passing the delay plate is better than 2° in at least one section.

48. A delay plate according to claim 42, wherein an accuracy of the orientation of polarization achieved in light passing the delay plate is better than 1° in at least one section.

49. A delay plate according to claim 42, wherein an accuracy of the phase of polarization achieved in light passing the delay plate is better than 2 nm in at least one section.

50. A delay plate according to claim 42, wherein an accuracy of the phase of polarization achieved in light passing the delay plate is better than 1 nm in at least one section.

51. A delay plate according to claim 42, wherein an accuracy of the thickness is better than 200 nm in at least one section.

52. A delay plate according to claim 42, wherein an accuracy of the thickness is better than 100 nm in at least one section.
